(19) United States
(12) Patent Application Publication
(10) Pub. No.: US 2024/0240060 A1
(43) Pub. Date: Jul. 18, 2024

(54) BIODEGRADABLE PRODUCTS AND METHODS OF MAKING THE SAME

(71) Applicant: ALADDIN MANUFACTURING CORPORATION, Calhoun, GA (US)

(72) Inventor: Melissa NORTH, Calhoun, GA (US)

(21) Appl. No.: 18/563,075

(22) PCT Filed: Jun. 16, 2022
(86) PCT No.: PCT/IB2022/055569

§ 371 Date: Nov. 21, 2023

Related U.S. Application Data
(60) Provisional application No. 63/215,615, filed on Jun. 28, 2021.

(51) Int. Cl. C09J 121/02; C09J 11/04; C09J 11/08; D06N 7/00

(52) U.S. Cl. CPC C09J 121/02; C09J 11/04; C09J 11/08; D06N 7/0065; D06N 2201/0254; D06N 2201/0263; D06N 2209/1614; D10B 2503/04

(57) ABSTRACT

The present disclosure provides biodegradable adhesive compositions and methods of making the same, including a latex and a biodegradation agent. wherein the latex preferably has a total solids content from 50 wt % to 90 wt %, and wherein the biodegradation agent is preferably present in an amount from about 0.5 wt % to 5 wt % based on the total solids content of the latex. Also, the present disclosure provides biodegradable flooring products and methods of making the same.

### TECHNICAL FIELD

This disclosure relates to various biodegradable products and methods of making the same. More particularly, this disclosure relates to the biodegradable adhesives and biodegradable flooring products and their methods of manufacture.

### BACKGROUND

The flooring products and coverings became essential products of everyday life. Conventional flooring products such as carpets, rugs, mats, and turfs are made up of various components and different types of materials. The components present in flooring products can include but are not limited to a primary backing, secondary backing, latex adhesives, liquid hot melt adhesives, and tuft material. It is common practice to produce fabrics such as carpets incorporating a primary backing of natural or synthetic plastic materials such as polypropylene in a woven or nonwoven fabric form. For example, broadloom carpets are normally produced by having a fabric backing of woven slit film polypropylene into which there is inserted a plurality of tufts by a tufting machine. Tufts may be made from natural or synthetic fibers, including wool, polyamides, polyester (e.g., polyethylene terephthalate or PET), polypropylene, and acrylics. An adhesive coating, e.g., of latex, is then applied as a fabric anchor coat to the side of the fabric backing opposite the pile side to lock the tufts in the fabric backing.

Rubber mats are often placed on bathroom and kitchen floors to absorb water and to provide a comfortable standing surface. These rubber mats are washable and can comprise a non-skid backing to create traction against the surface and protect against slippage.

One of the industry challenges is that at the end of the product life, most of the carpets and rugs are disposed in a landfill. Since many carpets and rugs components are not degradable, these products can stay in landfills for hundreds of years, which is not environmentally sustainable.

One approach to address this challenge is to eliminate the disposal of carpets in landfills by recycling at least the majority or even all parts of the carpet and/or rugs and to provide a desirable cradle-to-cradle product life cycle. However, in some instances a full carpet recycling is impossible, and other approaches are needed.

Thus, there is still a need to obtain flooring products that would allow their disposal without significantly affecting the surrounding environment. Still further, there is a need for methods of manufacturing such components, carpets, and rugs. These needs and other needs are at least partially satisfied by the present disclosure.

### SUMMARY

The present disclosure is directed to an adhesive composition comprising: a) a latex; and b) a biodegradation agent, wherein the latex preferably has a total solids content from 50 wt % to 90 wt %, and wherein the biodegradation agent is preferably present in an amount from about 0.5 wt % to 5 wt % based on the total solids content of the latex.

Such adhesive composition can be used to increase the biodegradability of products, for example, carpets and rugs comprising such adhesive composition. When disposed to the landfill, such products can degrade in an acceptable time period and allow an acceptable cradle-to-grave product life cycle.

In certain aspects, the latex can comprise a carboxylated styrene-butadiene (XSB) latex copolymer, a styrene-butadiene resin (SBR) latex, a butadiene-methyl methacrylate (BDMMA) latex, a styrene-acrylic latex, a pure acrylic latex, or any combination thereof.

In yet further aspects, the biodegradation agent can comprise one or more of a biodegradable polymer, a carrier resin, glutaric acid or its derivatives, carboxylic acid compounds or its derivatives, a swelling agent, an inorganic filler, an oxo-biodegradable additive, hydroperoxides, prodegradants, chemoattractant compounds, chemotaxis compounds, or any combination thereof. Also disclosed herein is a flooring product comprising a cured composition, wherein the cured composition comprises: a) a latex; and b) a biodegradation agent. In still further aspects, the flooring product comprises a backing comprising the disclosed herein cured compositions. In yet still further aspects, the cured composition is obtained by curing a composition comprising a latex and a biodegradation agent, wherein the latex has a total solids content from 50 wt % to 90 wt %, and wherein the biodegradation agent is present in an amount from about 0.5 wt % to 5 wt % based on the total solids content of the latex.

Also is disclosed a flooring product comprising: a) a primary backing material having a face side and a backside; b) a plurality of fibers attached to the primary backing material and extending from the face surface of the primary backing, wherein the plurality of fibers comprises a composition comprising: i) first polymer composition comprising a polyolefin, a polyamide, a polyester, or a combination thereof; and ii) a biodegradation agent.

In yet further aspects, the plurality of fibers degrade under conditions effective to cause biodegradability. In some exemplary and unlimiting aspects, the conditions effective to cause biodegradability can comprise exposure to an environment comprising one or more microorganisms.

In still further aspects, the disclosed herein flooring product can further comprise a precoat layer disposed on the back surface of the primary backing. In some exemplary and unlimiting aspects, the precoat layer can comprise any of the disclosed adhesive compositions herein.

In still further aspects, the flooring product can also comprise a primary backing comprising a second polymer composition comprising a polyolefin, a polyamide, a polyester, or a combination thereof. In still further aspects, the primary backing can also comprise any of the biodegradation agents disclosed herein.

In some exemplary and unlimiting aspects, the flooring product can comprise a tile, a resilient flooring product, a carpet tile, a broadloom carpet, an area rug, a rubber mat, or a turf. In yet still further aspects, the flooring product can be substantially fully recyclable.

Also disclosed herein is a fiber comprising: a) a polymer composition comprising a polyolefin, a polyamide, a polyester, or a combination thereof; and b) a biodegradation agent. Also disclosed are yarns comprising any of the disclosed herein fibers and articles comprising the yarns.

Still further disclosed herein are methods of making any of the disclosed herein adhesive compositions. In such exemplary aspects, the methods comprise forming a homogeneous composition comprising any of the disclosed herein latexes and biodegradation agents.

Still further, disclosed is a method of making any of the disclosed herein fibers, wherein the method comprises a) forming a first compound composition comprising: i) a biodegradation agent; and ii) carrier; b) extruding the first compound composition to form a plurality of pellets; c) mixing the first compound composition with a virgin polymer composition to form a homogeneous mixture, and d) extruding the homogeneous mixture to form the fiber.

In still further aspects, also disclosed herein are methods of making of any of the disclosed above flooring products, wherein the method can comprise a) disposing a curable composition comprising a latex and a biodegradation agent on a back surface of a flooring structure; wherein the latex has a total solids content from 50 wt % to 90 wt %, and wherein the biodegradation agent is present in an amount from about 0.5 wt % to 5 wt % based on the total solids content of the latex, and b) curing the curable composition to form a backing. While in other aspects, the methods of making the disclosed herein flooring products can comprise: a) providing a primary backing having a face side and a backside; and b) tufting a plurality of fibers through the primary backing such that at least a portion of the plurality of fibers extends from the face surface of the primary backing and wherein at least a portion of fibers is exposed at the back surface of the primary backing.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts an exemplary flooring product in accordance with one aspect of the disclosure

FIG. 2 depicts an exemplary flooring product in accordance with another aspect of the disclosure.

FIG. 3 depicts an exemplary flooring product in accordance with another aspect of the disclosure

### DETAILED DESCRIPTION

The present invention can be understood more readily by referencing the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein describes particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### DEFINITIONS

As used herein, the singular forms “a,” “an,” and “the” include plural referents unless the context clearly dictates otherwise. Thus, for example, reference to an “article” includes aspects having two or more such articles, or reference to a “product” includes aspects having two or more such products unless the context clearly indicates otherwise.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

The term “comprising” and variations thereof as used herein is used synonymously with the term “including” and variations thereof and are open, non-limiting terms. Although the terms “comprising” and “including” have been used herein to describe various aspects, the terms “consisting essentially of” and “consisting of” can be used in place of “comprising” and “including” to provide for more specific aspects of the invention and are also described.

For the terms “for example” and “such as,” and grammatical equivalences thereof, the phrase “and without limitation” is understood to follow unless explicitly stated otherwise.

Other than in the examples, or where otherwise noted, all numbers expressing quantities of ingredients, reaction conditions, and so forth used in the specification and claims are to be understood at the very least and not as an attempt to limit the application of the doctrine of equivalents to the scope of the claims, to be construed in light of the number of significant digits and ordinary rounding approaches. Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges and individual numerical values within that range. Thus, for example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

“Optional” and “optionally” means that the subsequently described event or circumstance may or may not occur and that the description includes instances where said event or circumstance occurs and instances where it does not.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate, effective amount will be readily determined by one of ordinary skill in the art using only routine experimentation.

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or a section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

As used herein, the term “substantially,” in, for example, the context “substantially identical” or “substantially similar” refers to a method or a product, or an article, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

As used herein, the term “composition” is intended to encompass a product comprising the specified ingredients in the specified amounts, as well as any product which results, directly or indirectly, from a combination of the specified ingredients in the specified amounts.

A weight percent (wt. %) of a component, unless specifically stated to the contrary, is based on the total weight of the formulation or composition in which the component is included.

The term “biodegradation rate” refers to the time for a disclosed component to biodegrade to a specific degree. For instance, a biodegradation rate of 5% in 30 days means that the biogases emitted (CO₂+CH₄) represent 5% by weight of the original carbon content of the sample. Biodegradation rate is measured according to the ASTM-D5511 testing standard.

The term “polymer” may comprise homopolymers, copolymers, such as, for example, block, graft, random, and alternating copolymers, terpolymers, etc., and blends and modifications thereof. Furthermore, unless otherwise specifically limited, the term “polymer” shall include all possible structural isomers; stereoisomers including, without limitation, geometric isomers, optical isomers, or enantiomers; and/or any chiral molecular configuration of such polymer or polymeric material. These configurations include, but are not limited to, isotactic, syndiotactic, and atactic configurations of such polymer or polymeric material. The term “polymer” shall also include polymers made from various catalyst systems, including, without limitation, the Ziegler-Natta catalyst system and the metallocene/single-site catalyst system.

As used herein, the term “woven” may comprise a fabric having a structure of individual fibers, filaments, and/or threads that are interlaid in an identifiable repeating manner.

The term “nonwoven,” as used herein, may comprise a web having a structure of individual fibers, filaments, and/or threads that are interlaid but not in an identifiable repeating manner as in a knitted or woven fabric. Nonwoven fabrics or webs, according to certain embodiments of the invention, may be formed by any process conventionally known in the art, such as, for example, meltblowing processes, spunbonding processes, hydroentangling, air-laid, and bonded carded needled web processes.

The term “meltspun,” as used herein, may comprise fibers that are formed by extruding molten thermoplastic material as filaments from a plurality of fine, usually circular or trilobal, die capillaries of a spinneret and solidifying the extruded filaments by cooling them as they emerge from the die capillaries.

The term “spunbond,” as used herein, may comprise fibers that are formed by extruding molten thermoplastic material as filaments from a plurality of fine, usually circular or trilobal, capillaries of a spinneret with the diameter of the extruded filaments then being rapidly reduced. According to an embodiment of the invention, spunbond fibers are generally not tacky when they are deposited onto a collecting surface and may be generally continuous.

The term “meltblown,” as used herein, may comprise fibers formed by extruding a molten thermoplastic material through a plurality of fine die capillaries as molten threads or filaments into converging high velocity, usually hot, gas (e.g., air) streams which attenuate the filaments of molten thermoplastic material to reduce their diameter, which may be to microfiber diameter, according to certain embodiments of the invention. According to an embodiment of the invention, the die capillaries may be circular. Thereafter, the meltblown fibers are carried by the high-velocity gas stream and are deposited on a collecting surface to form a web of randomly disbursed meltblown fibers. Meltblown fibers are microfibers that may be continuous or discontinuous and are generally tacky when deposited onto a collecting surface.

As used herein, the term “bicomponent fibers” can comprise fibers formed from at least two different polymers extruded from separate extruders but spun together to form one fiber. Bicomponent fibers are also sometimes referred to as conjugate fibers or multicomponent fibers. The polymers are arranged in a substantially constant position in distinct zones across the cross-section of the bicomponent fibers and extend continuously along the length of the bicomponent fibers. The configuration of such a bicomponent fiber may be, for example, a sheath/core arrangement wherein one polymer is surrounded by another, or can be a side-by-side arrangement, a homo-homo arrangement, a pie arrangement, or an “islands-in-the-sea” arrangement, each as is known in the art of multicomponent, including bicomponent, fibers. In some aspects, the “bicomponent fibers” can be thermoplastic fibers comprising a core fiber made from one polymer encased within a thermoplastic sheath made from a different polymer or have a side-by-side arrangement of different thermoplastic fibers. The first polymer often melts at a different, typically lower, temperature than the second polymer. In the sheath/core arrangement, these bicomponent fibers provide thermal bonding due to the melting of the sheath polymer while retaining the desirable strength characteristics of the core polymer.

As used herein, the term “chemoattractant” refers to substances, compounds, or compositions that attract microorganisms of a particular type and serve as a food source for such microorganisms.

As used herein, the term “prodegradants” refers to any additives that can trigger and accelerate the degradation of a polymer.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or description that the steps are to be limited to a specific order, it is in no way intended that an order be inferred in any respect. This holds for any possible non-express basis for interpretation, including matters of logic concerning the arrangement of steps or operational flow, plain meaning derived from grammatical organization or punctuation, or the number or type of aspects described in the specification.

The present invention may be understood more readily by reference to the following detailed description of various aspects of the disclosure and the examples included therein and their previous and following description.

### COMPOSITIONS AND PRODUCTS

In one aspect, disclosed herein is an adhesive composition comprising: a) a latex; and b) a biodegradation agent. In certain aspects, the latex can have a total solids content from 50 wt % to 90 wt %, including exemplary values of 55 wt %, 60 wt %, 65 wt %, 70 wt %, 75 wt %, 80 wt %, and 85 wt %. In still further aspects, the biodegradation agent can be present in an amount from 0.5 wt % to 5 wt % based on the total solids content of the latex, including exemplary values of 0.7 wt %, 1.0 wt %, 1.2 wt %, 1.5 wt %, 1.7 wt %, 2.0 wt %, 2.2 wt %, 2.5 wt %, 2.7 wt %, 3.0 wt %, 3.2 wt %, 3.5 wt %, 3.7 wt %, 4.0 wt %, 4.2 wt %, 4.5 wt %, and 4.7 wt %.

In still further aspects, any known in the art latex suitable for the desired application can be utilized. In some exemplary and unlimiting aspects, the latex can comprise a carboxylated styrene-butadiene (XSB) latex copolymer, a styrene-butadiene resin (SBR) latex, a butadiene-methyl methacrylate (BDMMA) latex, a styrene-acrylic latex, a pure acrylic latex, or any combination thereof.

In still further aspects, the disclosed herein adhesive composition can degrade under conditions effective to cause biodegradability. For example, and without limitations, the conditions effective to cause biodegradability can comprise exposure to an environment comprising one or more microorganisms. In certain aspects, when the adhesive composition disclosed herein is exposed to the environment comprising one or more microorganisms, this exposure can trigger a series of chemical and biological processes that would cause a degradation of the composition. In certain aspects, the conditions effective to cause biodegradability can comprise an aerobic waste management route. While in other aspects, the conditions effective to cause biodegradability can comprise an anaerobic waste management route. In yet still further aspects, the conditions effective to cause biodegradability can comprise both an aerobic waste management route and an anaerobic waste management route. It is understood that any known in the art aerobic and anaerobic waste management routes can be utilized. For example, and without limitations, the aerobic or anaerobic waste management route comprises digester, landfill, or compost, or any combination thereof.

In still further aspects, the biodegradation agent can comprise one or more of a biodegradable polymer, a carrier resin, glutaric acid or its derivatives, carboxylic acid compounds or its derivatives, a swelling agent, an inorganic filler, an oxo-biodegradable additive, hydroperoxides, prodegradants, chemoattractant compounds, chemotaxis compounds, or any combination thereof. Some exemplary biodegradation agents are disclosed in WO2016/076724, US20200291194, U.S. Pat. No. 9,382,416, and/or US20080103232, the contents of which are incorporated in their whole entirety. These disclosed degradation agents can be used in the current disclosure in any combination that provides for the desired result.

In still further aspects, the biodegradation agents can trigger the degradation of the polymer by any suitable mechanisms. In certain aspects, the degradation mechanisms can include a combination of oxidation and biodegradation, photo-degradation, formation of free radicals, accelerating the degradation reaction by using biodegradation agents capable of catalyzing it, or use of additives that comprise biodegradable polymers. In certain aspects, and as disclosed above, the biodegradation agents can comprise chemoattractants that are configured to attract the microorganisms present in the landfill, for example, to cause digesting of the disclosed compositions or product by the microorganisms. In still further aspects, the biodegradation agent can also comprise microorganisms that can digest the desired components. In still further aspects, the one or more microorganisms can comprise bacteria and/or fungi. Some exemplary microorganisms are shown in U.S. Pat. No. 9,382,416, the content of which is incorporated herein in its whole entirety.

In still further aspects, the biodegradation agent comprises a composition comprising calcium carbonate, a polyester, and a polycaprolactone. While in other aspects, the biodegradation agent can comprise a composition comprising glutaric acid or its derivatives and an aliphatic polyester. In certain exemplary and unlimiting aspects, the glutaric acid can be a propylglutaric acid. In yet other exemplary aspects, the polycaprolactone can comprise polycaprolactone, poly (lactic acid), poly (glycolic acid), poly (lactic-co-glycolic acid), or a combination thereof. In still further aspects, the biodegradation agent can also comprise a carboxylic acid compound or its derivative. In some exemplary aspects, the carboxylic acid can comprise a hexadecenoic acid compound.

In some aspects, the chemoattractant can comprise sugars such as, for example, furanone or furanone derivatives. Some exemplary and unlimiting furanones can comprise 3,5-dimethylyentenyl-dihydro-2(3H)furanone isomer mixtures, emoxyfurane, or N-acyl homoserine lactones, or any combination thereof. Additional examples of sugar can include glucose, fructose, ribose, serine, aspartate, malate, succinate, galactonate, galactose, fumarate, pyruvate, and any other known L- and D-sugars.

In still further aspects, the biodegradable polymer can comprise any known in the art biodegradable polymers suitable for the specific application. For example, and without limitations, the biodegradable polymer can comprise polylactic acid, poly(lactic-co-glycolic acid), polypropylene carbonate, polycaprolactone, polyhydroxyalkanoate, chitosan, gluten, or one or more aliphatic/aromatic polyesters.

In still further aspects, the one or more aliphatic/aromatic polyesters comprise polybutylene succinate, polybutylene succinateadipate, polybutylene succinate-sebacate, or polybutylene terephthalate-coadipate, or a mixture thereof.

In certain aspects, the biodegradation agent can also comprise a swelling agent. In such exemplary aspects, the swelling agents can assist the penetration of the microorganisms and to enhance the degradation. For example, and without limitation, the swelling agents that can be present in the biodegradation agents can comprise one or more of a natural fiber, a cultured colloid, a cyclo-dextrin, polylactic acid, or mixtures thereof.

In still further aspects, the biodegradation agents can comprise naturally occurring or synthetic products. In some aspects, the biodegradation agent can further comprise a degradation-controlling agent.

In still further aspects, the biodegradation agent can comprise an aliphatic polyester resin, for example, poly(1,4-butylene adipate-co-polycaprolactam).

It is understood that any combination of the disclosed above components can be present in the biodegradation agent in any relative amount. For example and without limitations, it is understood that any of the components can be present in an amount from 0 wt % to 100 wt % relative to each other, based on a total weight of the biodegradation agent, including exemplary values of 5 wt %, 1 wt %, 10 wt %, 20 wt %, 40 wt %, 50 wt %, 60 wt %, 70 wt %, 80 wt %, 90 wt %, and 99 wt %.

In yet still further aspects, the adhesive composition can comprise any of the biodegradation agents sold as solid, liquid or powder masterbatches such as “Eco-One®” from EcoLogic® LLC; “SR5300” from ENSO Plastics; “EcoPure” from Bio-Tec Environmental; “ECM masterbatch pellets” from ECM biofilms; “BioSphere” from BiosPhere Plastic; “Enso Restore” from ENSO Plastics; “MECO 1” from Hybrid Green, or “Ciclo™” from Ciclo Textiles; “EPS Powder” from BiosPhere Plastic; “302 Additive” from BiosPhere Plastic.

In still further aspects, the adhesive composition can further comprise a filler. It is understood that the filler can comprise one or more of calcium carbonate, aluminum trihydrate, barite, feldspar, cullet, fly ash, limestone, or any combination thereof. However, any other known in the art fillers that are suitable for the desired applications can also be utilized. It is understood that the filler can be present in any desired amount from 0 wt % to less than 100% of the total weight of the adhesive composition, including exemplary aspects of al wt %, 10 wt %, 20 wt %, 30 wt %, 40 wt %, 50 wt %, 60 wt %, 70 wt %, 80 wt %, and 90 wt %.

In still further aspects, if needed, the adhesive composition can further comprise flame retardants, tackifiers, dispersing agents, and the like. In still further aspects, disclosed herein is a flooring product comprising a cured composition, wherein the cured composition comprises: a) a latex; and b) a biodegradation agent. In still further aspects, the flooring product comprises a backing. In yet still further aspects, the backing can comprise the disclosed herein cured composition. In some exemplary and unlimiting aspects, the cured composition can be obtained by curing a composition comprising a latex and a biodegradation agent, wherein the latex has a total solids content from 50 wt % to 90 wt %, and wherein the biodegradation agent is present in an amount from about 0.5 wt % to 5 wt % based on the total solids content of the latex.

It is understood that any of the disclosed above latexes and biodegradation agents can be present in the backing disclosed herein.

In still further aspects, the backing can comprise the curable composition and comprise from 15 to 40 oz/unit area of the flooring product, including exemplary values of 17, 20, 22, 25, 27, 30, 32, 25, and 37 oz/unit area. In still further aspects, the cured composition can have a thickness of 0.3 mm to 3 cm, including exemplary values of 0.5 mm, 0.7mm, 1 mm, 2 mm, 5 mm, 7 mm, 1 cm, 1.5 cm, 2 cm, and 2.5 cm. In yet further aspects, the thickness can be between 0.5 mm to 2. 5 cm or between 1 mm to 1 cm.

In still further aspects, the curable composition can degrade under conditions effective to cause biodegradability. In such aspects, the curable composition can degrade under any of the disclosed above conditions. In some exemplary and unlimiting aspects, the curable composition degrades in the presence of microorganisms in aerobic or anaerobic waste management routes, as disclosed above.

In still further aspects, the curable composition can further comprise a filler. Any of the disclosed above fillers can be utilized.

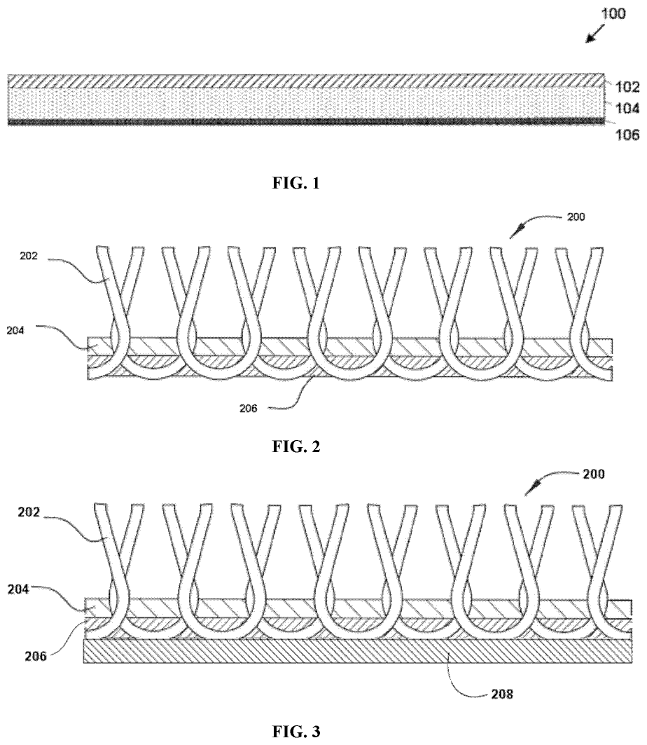

An exemplary flooring product as disclosed above is shown in FIG. 1. In this exemplary aspect, the flooring product is a bathmat. The exemplary bathmat 100 comprises a face layer 102, an optional foam layer 104, and a backing layer 106, wherein the backing layer comprises the cured composition as described herein. It is understood that the flooring product shown in FIG. 1 is exemplary only and can also comprise additional layers, such as various backings, various utility layers (for example, sound diminishing layers, slip resistance layers, etc.). Any known in the art layers suitable for the desired operations can be used. It is further understood that these layers con comprise any known compositions suitable for the desired operation and compatible with the disclosed herein backing.

In still further aspects, the backing of the disclosed herein flooring product can comprise a pattern. The pattern can be chosen depending on the aesthetics, utility of the flooring product, the desired application, or a combination thereof. In still further aspects, the backing of the disclosed herein flooring product is a non-slip backing. In still further aspects, the flooring product is washable under conventional conditions, such as, for example, and without limitation with the use of conventional washing machines.

In addition, or in alternative disclosed herein is a flooring product comprising: a) a primary backing material having a face side and a back side; b) a plurality of fibers attached to the primary backing material and extending from the face surface of the primary backing, wherein the plurality of fibers comprises a composition comprising: i) first polymer composition comprising a polyolefin, a polyamide, a polyester, or a combination thereof; and ii) a biodegradation agent. In certain aspects, the plurality of fibers disclosed herein can degrade under conditions effective to cause biodegradability.

It is understood that the conditions effective to cause biodegradability can comprise any of the disclosed above conditions effective to cause biodegradability. In some aspects, the conditions can comprise an aerobic and anaerobic waste management routes.

An exemplary flooring product 200, according to the aspects of the disclosure, is shown in FIGS. 2-3. As shown in FIGS. 2-3, the plurality of fibers 202 are attached or tufted into the primary backing 204 and extending from the face surface of the primary backing 204. As it can be seen, a portion of the plurality of fiber is embedded within the primary backing material, such that a portion of the plurality of fibers extends from the back surface of the primary backing. Depending on the desired application or the desired type of the flooring product, the portion of the fibers extending from the back surface of the primary backing can form back stitches or form loops. The plurality of fibers can further form a yarn.

It is understood that in some aspects, the flooring product can comprise more than one plurality of fibers. For example, and without limitations, the flooring product can comprise a first plurality of fibers and a second plurality of fibers, wherein the first and the second plurality of fibers can be the same or different. In still further aspects, the yarn formed from the plurality of fibers can comprise only the first plurality of fibers, only the second plurality of fibers, or both the first and the second plurality of fibers. It is understood that more than two pluralities of fibers can be present. Any additional plurality of fibers can comprise of the disclosed herein materials suitable for the desired application.

It is also understood that any known in the art and suitable for the desired application plurality of fibers can be utilized. For example, the plurality of fibers can comprise staple fibers. Yet, in other aspects, the plurality of fibers can comprise bulk continuous filament fibers.

As disclosed herein, the plurality of fibers can comprise a composition comprising a first polymer composition comprising a polyolefin, a polyamide, a polyester, or a combination thereof.

In some aspects, wherein the polyamide is present, the polyamide can be formed by condensation polymerization of a dicarboxylic acid and a diamine. Representative examples of such dicarboxylic acids include terephthalic acid, isophthalic acid, 2,6-naphthalene dicarboxylic acid, 3,4′-diphenylether dicarboxylic acid, hexahydrophthalic acid, 2,7-naphthalenedicarboxylic acid, phthalic acid, 4,4′-methylenebis(benzoic acid), oxalic acid, malonic acid, succinic acid, methyl succinic acid, glutaric acid, adipic acid, 3-methyladipic acid, pimelic acid, suberic acid, azelaic acid, sebacic acid, 1,11-undecanedicarboxylic acid, 1,10-dodecanedicarboxylic acid, 1,12-dodecanedicarboxylic acid, hexadecanedioic acid, docosanedioic acid, tetracosanedioic acid, 1,4-cyclohexanedicarboxylic acid, 1,3-cyclohexanedicarboxylic acid, 1,2-cyclohexanediactic acid, fumaric acid, and maleic acid. Representative examples of such diamines include ethylene diamine, tetramethylene diamine, hexamethylene diamine, 1,9-nonanediamine, 2-methyl pentamethylene diamine, trimethyl hexamethylene diamine (TMD), m-xylylene diamine (MXD), and 1,5-pentanediamine.

In some aspects, the polyamide can be formed by condensation polymerization of an amino acid (such as 11-aminoundecanoic acid) or ring-opening polymerization of a lactam (such as caprolactam or ω-aminolauric acid).

In certain aspects, when the first polymer composition comprises a polyamide, the polyamide can include, but not limited to, polyamide 6, polyamide 11, polyamide 12, polyamide 46, polyamide 410, polyamide 4T, polyamide 56, polyamide 510, polyamide D6, polyamide DT, polyamide DI, polyamide 66, polyamide 610, polyamide 611, polyamide 612, polyamide 6T, polyamide 6I, polyamide MXD6, polyamide 9T, polyamide 1010, polyamide 10T, polyamide 1212, polyamide 12T, polyamide PACM12, and polyamide TMDT, polyamide 611, and polyamide 1012; polyphthalimides such as polyamide 6T/66, polyamide LT/DT, and polyamide L6T/6I; and aramid polymers. In still further aspects, the polyamide can comprise a polyamide copolymer, for example but not limited to a polyamide 6/polyamide 66 copolymer, polyamide 6/polyamide 6T copolymer, polyamide 61/polyamide6T copolymer, polyamide 66/polyamide 6T copolymer, or polyamide 12/polyamide MAMCI copolymer.

In yet other aspects, when the first polymer composition comprises a polyamide, the polyamide can comprise nylon 6, nylon 66, nylon 666, nylon 610, nylon 512, nylon 11, or nylon 12, or a combination thereof. In still further aspects, the polyamide is polyamide 6.

In still further aspects, the first polymer composition can comprise a polyester. A polyester, as defined herein, is a synthetic linear polymer whose repeating units contain ester functional groups, wherein these ester functional groups are integral members of the linear polymer chain.

Typical polyesters, as used in the present disclosure, can be formed by condensation of a dicarboxylic acid and a diol. Representative examples of such dicarboxylic acids include terephthalic acid, isophthalic acid, 2,6-naphthalene dicarboxylic acid, 3,4′-diphenylether dicarboxylic acid, hexahydrophthalic acid, 2,7-naphthalene dicarboxylic acid, phthalic acid, 4,4′-methylenebis(benzoic acid), oxalic acid, malonic acid, succinic acid, methyl succinic acid, glutaric acid, adipic acid, 3-methyladipic acid, pimelic acid, suberic acid, azelaic acid, sebacic acid, 1,11-undecanedicarboxylic acid, 1,10-dodecanedicarboxylic acid, 1,12-dodecanedicarboxylic acid, hexadecanedioic acid, docosanedioic acid, tetracosanedioic acid, 1,4-cyclohexanedicarboxylic acid, 1,3-cyclohexanedicarboxylic acid, 1,2-cyclohexanediacetic acid, fumaric acid, and maleic acid. Representative examples of such diols include monoethylene glycol, diethylene glycol, triethylene glycol, poly(ethylene ether)glycols, 1,3-propanediol, 1,4-butanediol, poly(butylene ether)glycols, pentamethylene glycol, 1,6-hexanediol, 1,8-octanediol, 1,10-decanediol, 1,12-dodecanediol, 1,14-tetradecanediol, 1,16-hexadecanediol, cis-1,4-cyclohexanedimethanol, and trans-1,4-cyclohexanedimethanol.

In still further aspects, the first polymer composition comprises a polyester, the polyester can comprise polyethylene terephthalate ester, polypropylene terephthalate, polytrimethylene terephthalate ester, polybutylene terephthalate ester, or any combination thereof. It is understood that the mentioned herein polyesters comprise both homopolymers and copolymers. For example, when the polyethylene terephthalate ester is discussed, it can include homopolymers of the polyethylene terephthalate ester and copolymers of the polyethylene terephthalate ester. Similarly, when the polybutylene terephthalate ester is discussed, it can include homopolymers and copolymers of the polybutylene terephthalate ester and the like. In still further aspects, the plurality of fibers can comprise polyethylene terephthalate (PET), polytrimethylene terephthalate (PTT), or combinations thereof. In some other aspects, the exemplary polyesters can include poly(ethylene terephthalate) (PET), poly(trimethylene terephthalate) (PTT), poly(butylene terephthalate) (PBT), poly(ethylene isophthalate), poly(octamethylene terephthalate), poly(decamethylene terephthalate), poly(pentamethylene isophthalate), poly(butylene isophthalate), poly(hexamethylene isophthalate), poly(hexamethylene adipate), poly(pentamethylene adipate), poly(pentamethylene sebacate), poly(hexamethylene sebacate), poly(1,4-cyclohexylene terephthalate), poly(1,4-cyclohexylene sebacate), poly(ethylene terephthalate-co-sebacate), and poly(ethylene-co-tetramethylene terephthalate).

In still further aspects, when the first polymer composition comprises a polyolefin, the polyolefin can comprise polyethylene, polypropylene, or a combination thereof. While in still further aspects, the plurality of fibers can comprise polyethylene.

In still further exemplary and unlimiting aspects, the first polymer composition can also comprise acrylics, viscose, rayon, cellulose based materials, wool, cotton, linen, or any combination thereof.

In still further aspects, the plurality of fibers can have a bicomponent structure. In such aspects, the fiber can comprise a core and a sheath. In such aspects, the core and the sheath of the fiber can comprise any of the disclosed above first polymer compositions. In certain aspects, the core and the sheath can have the same polymer composition. While in some aspects, when the polymer composition of the core and the sheath can comprise the same polymer, the core or the sheath, depending on the application, can comprise a PET, while the sheath or the core can comprise a low melt co-PET and the like. While in other aspects, the core and the sheath can have a different polymer composition. In yet other aspects, the bicomponent fibers can also be formed in a side-by-side arrangement, an islands-in-the-sea arrangement, an eccentric arrangement, a segmented-pie arrangement, or any combination thereof.

In still further aspects, the plurality of fibers can form a yarn and include a tufted cut and loop arrangement, for example, having ⅛, 1/10, or 3/16 gauges. Additionally, in some aspects, for instance, the yarn can be sized at 300-1500 denier, including exemplary values of 400, 500, 600, 700, 800, 900, 1,000, 1,200, 1,300, and 1,400 deniers. In yet still further aspects, the plurality of fibers can have 2-20 denier per filament, including exemplary values of 3, 5, 8, 10, 12, 15, and 18 denier per filament.

Additionally, in certain aspects, for example, the disclosed herein flooring products can have a face-weight of 16-80 oz/yd², including exemplary values of 20 oz/yd², 25 oz/yd², 30 oz/yd², 35 oz/yd², 40 oz/yd², 45 oz/yd², 50 oz/yd², 55 oz/yd², 60 oz/yd², 65 oz/yd², 70 oz/yd², and 75 oz/yd². For instance, in some aspects, the flooring product can have a face-weight of 40-80 oz/yd2. The face of the flooring product can also be about 12-15 feet wide.

In still further aspects, the composition of the plurality of fibers comprises any of the disclosed above biodegradation agents. In still further aspects, the biodegradation agent can be present in the composition in any amount between 0.5 wt % to 5 wt % of the composition, including exemplary values of 1 wt %, 1.2 wt %, 1.5 wt %, 1.7 wt %, 2.0 wt %, 2.2 wt %, 2.5 wt %, 2.7 wt %, 3.0 wt %, 3.2 wt %, 3.5 wt %, 3.7 wt %, 4.0 wt %, 4.2 wt %, 4.5 wt %, and 4.7 wt % the composition.

In still further aspects, the composition of the plurality of fibers can further comprise one or more additives including, but not limited to: flame retardant additives, for example decabromodiphenyl ether and triarylphosphates such as triphenyl phosphate; reinforcing agents such as glass fibers; thermal stabilizers, for example thermal conductivity improvers such as zinc oxide and titanium oxide; ultraviolet light stabilizers such as resorcinol monobenzoates, phenyl salicylate and 2-hydroxybenzophenones; hindered amine stabilizers such as benzotriazole, benzophenone, oxalanilide, and cerium oxide; impact modifiers; flow enhancing additives; ionomers; liquid crystal polymers; fluoropolymers; olefins including cyclic olefins; polyamides; ethylene vinyl acetate copolymers; stabilizing agents such as ortho-phosphoric acid, triphenylphosphate, and triethylphosphino acetate; delustering agents such as titanium oxide; carriers such as o-phenylphenol, p-phenylphenol, o-dichlorobenzene, trichlorobenzene, monochlorobenzene, biphenyl, methyl salicylate, butyl benzoate, benzyl benzoate, benzoic acid, benzalacetone, and methyl cinnamate; leveling agents such as bishydroxymethyloxazoline, diaryl ethers, ditolyl ether, sodium di-naphthylmethane-B,B-disulfonate, ammonium dodecylbenzene sulfonate, sodium tetrapropylbenzene sulfonate, homopolymers or oligomers of N-vinylpyrrolidone and poly(tetrahydrofuran); and porosity additives such as metal oxalate complexes, organic sulfonate salts, jade powder, and zeolite powder.

In still further aspects, as discussed above and as it can be seen in FIG. 2, the plurality of fibers 202 can be exposed at the back side of the primary backing 204. In certain aspects, to form the flooring product 200, a precoat layer 206 can be disposed on the back surface of the primary backing. It is understood that such a precoat layer can anchor the plurality of the fibers to the primary backing. In applying the precoat layer 206, however, the exemplary loops of the plurality of fibers 202 do not need to be further fused to the primary backing 204, such as with relative movement between a heated roll or knife and the loops of the tufts as is known in the prior art.

In some aspects, the precoat layer can comprise the adhesive composition disclosed above. More specifically, the precoat layer can comprise the latex as disclosed above and any of the disclosed above biodegradation agents.

Yet in other exemplary and unlimiting aspects, the precoat layer can comprise other adhesives. For example, the precoat layer can be a glue. For instance, in some aspects, the precoat layer can be a liquid glue comprising, for example, a copolymer of polyethylene terephthalate (coPET) or copolymer of polytrimethylene terephthalate (coPTT). Yet, in other aspects, the precoat layer can comprise a liquid hot melt adhesive, e.g., molten CoPET. In some aspects, the precoat layer can include a liquid hot-melt adhesive. In such exemplary aspects, the liquid hot melt adhesive can comprise a copolymer of one or more polyamide polymers discussed above. In yet other aspects, the liquid hot melt adhesive can comprise a copolymer of a polyolefin, e.g., polypropylene (PP).

It is understood that in some aspects, the precoat layer can comprise the disclosed above adhesive composition comprising latex and biodegradation agent and an additional (further) adhesive material that can comprise any of the disclosed above adhesives that are not latex-based (such as glues, various liquid hot melt adhesives, etc.). Additional examples for various flooring product components can be found in WO 2021/055414 and/or WO 2019/182738, the contents of which are incorporated herein in their full entirety.

In aspects where the liquid hot melt adhesives are used, such adhesives can have a melting temperature from 130° C.to 200° C., including exemplary values of 140° C., 150° C., 160° C., 170 ° C., 180° C., and 190° C.

In some aspects, the precoat can have a weight of 3-16 oz/yd², including exemplary values of 4 oz/yd², 4.5 oz/yd², 5 oz/yd², 5.5 oz/yd², 6 oz/yd², 6.5 oz/yd², 7 oz/yd², 7.5 oz/yd², 8 oz/yd², 8.5 oz/yd², 9 oz/yd², 9.5 oz/yd², 10 oz/yd², 10.5 oz/yd², 11 oz/yd², 11.5 oz/yd², 12 oz/yd², 12.5 oz/yd², 13 oz/yd², 13.5 oz/yd², 14 oz/yd², 14.5 oz/yd², and 15 oz/yd².

In still further aspects, the primary backing of the disclosed herein flooring product can comprise a second polymer composition comprising a polyolefin, a polyamide, a polyester, or a combination thereof.

In certain aspects, the second polymer composition comprises a polyamide, and the polyamide comprises nylon 6, nylon 66, nylon 666, nylon 610, nylon 512, nylon 11, or nylon 12, or a combination thereof. While in other aspects, the second polymer composition comprises a polyester, and the polyester comprises polyethylene terephthalate ester, polypropylene terephthalate, polytrimethylene terephthalate ester, polybutylene terephthalate ester, or any combination thereof. While still in further aspects, the second polymer composition comprises a polyolefin, and the polyolefin comprises polyethylene, polypropylene, or a combination thereof.

In still further aspects, the first polymer composition can be substantially identical to the second polymer composition.

As discussed above, the primary backing can be woven or nonwoven. In some aspects, the primary backing comprises polyethylene, polypropylene, or a combination thereof. In other some aspects, the primary backing can be a polyester primary backing. In such aspects, the primary backing can include polyethylene terephthalate (PET), polytrimethylene terephthalate (PTT), or a combination thereof.

Yet in other aspects, the primary backing can comprise polyester or polyamide and can include less than 10 wt % of a polyolefin, less than 9 wt % of a polyolefin, less than 8 wt % of a polyolefin, less than 7 wt % of a polyolefin, less than 6 wt % of a polyolefin, less than 5 wt % of a polyolefin, less than 4 wt % of a polyolefin, less than 3 wt % of a polyolefin, less than 2 wt % of a polyolefin, or less than 1 wt % of a polyolefin. In still further aspects. In certain aspects, for example, the primary backing can include about 5% of a polyolefin. In such exemplary aspects when the polyolefin is present, the polyolefin can have a melting point from 105° C.to 180° C., including exemplary values of 110° C., 115° C., 120° C., 12° C., 130° C., 135° C., 140° C., 145° C., 150° C., 155° C., 160° C., 165° C., 170° C., and 175° C. In still further aspects, for instance, the polyolefin can have a melting point of at least 150° C. In certain exemplary and unlimiting aspects, the polyolefin can include polyethylene (e.g., an ethylene copolyester). Without intending to be limited by any theory, the addition of the polyolefin can improve the tenacity of the primary backing for processing while only slightly decreasing the strength and dimensional stability of the final flooring product.

In further aspects, for example, the primary backing can also comprise a copolyester to improve tenacity.

As further noted above, the primary backing can be a woven fabric backing. In some embodiments, for example, the primary backing can comprise a slit tape. However, it is understood that the primary woven fabric backings are not limited to the slit tape and can instead comprise round, trilobal, or rectangular filaments as understood by one of ordinary skill in the art. In certain aspects, in the weft direction, the woven primary backing may comprise a slit tape at 11-20 picks per inch, including exemplary values of 12, 13, 14, 15, 16, 17, 18, and 19 picks per inch, 95 millimeter width, and 800-1,050 denier, including exemplary values of 850 denier, 900 denier, 950 denier, and 1,000 denier. In the warp direction, the woven primary backing can comprise slit tape at 20-31 ends per inch, including exemplary values of 221, 22, 23, 24, 25,26,27,28, 29, and 30 ends per inch, 45 millimeter width, and 400-500 denier, including exemplary values of 410, 420, 430, 440, 450, 460, 470, 480, and 490 denier. An example of a suitable woven primary backing is the 18 pick Artis® from Propex, 4019 Industry Drive, Chattanooga, TN.

In still further aspects, and as disclosed above, the primary backing can be a nonwoven primary backing. In such exemplary aspects, the nonwoven fabric primary backing comprises a spunbond, meltblown, or meltspun fabric. In some aspects, for example, the nonwoven primary backing can comprise an 80-150 gsm, including exemplary values of 90, 100, 110, 120, 130, and 140 gsm spunbond. In other exemplary aspects, the nonwoven primary backing can be bonded and entangled via hydroentangling or needling before tufting. In further exemplary aspects, the nonwoven fabric backing can comprise up to 1 wt %, up to 5 wt %, up to 7 wt %, up to 10 wt %, up to 12 wt %, up to 15 wt %, up to 17 wt %, and 20% of a low melt copolyester (e.g., coPET) or a low melt copolymer of a polyamide polymer based on the total weight of primary backing.

In still further exemplary and non-limiting aspects, the nonwoven primary backing can comprise a plurality of PET filaments and a plurality of coPET filaments randomly interspersed among the plurality of polyester filaments. This random interspersion can be achieved via, for example, a spunbonding or meltblowing process. In other aspects, the coPET filaments can be distributed evenly and/or according to a pattern as understood by one of ordinary skill in the art. In still further aspects, the nonwoven primary backing can comprise all or a portion of bicomponent fibers having a core formed at least in part by PET and a low melt sheath formed at least in part by coPET. In yet other aspects, for instance, the nonwoven primary backing can comprise bicomponent fibers having a side-by-side arrangement of PET and coPET.

In certain aspects, the disclosed herein flooring products can have a weight of the primary backing of 2-6 oz/yd², including exemplary values of 2.5 oz/yd², 3 oz/yd², 3.5 oz/yd², 4 oz/yd², 4.5 oz/yd², 5 oz/yd², and 5.5 oz/yd². In still further aspects, the disclosed herein flooring products can have a weight of the primary backing of 2-4 oz/yd². Such weights may also improve tear resistance, tensile strength, and tuft bind strength. However, while going beyond these weights can further improve tear resistance, tensile strength, and tuft bind strength, the primary backing can also become uneconomical as too much raw material is required to make a saleable product.

In certain aspects, the flooring products disclosed herein are a unitary construction entirely made of substantially like or similar materials. In such exemplary aspects, the first polymer composition and the second polymer composition are substantially the same. In still further aspects, these flooring products can be substantially fully recyclable.

In some exemplary aspects, the flooring product can include a polyester primary backing with a plurality of polyester fibers tufted therethrough. Even further, such construction can also include liquid hot melt adhesive that is a copolymer of polyethylene terephthalate (CoPET). While in other exemplary aspects, the flooring products can include a polyamide fabric backing with a plurality of polyamide fibers tufted therethrough. Still, further, such an exemplary construction can also include a liquid adhesive that is a copolymer of one of the polyamide polymers.

Likewise, the flooring product described herein can include a polypropylene (PP) primary backing with a plurality of polypropylene (PP) fibers tufted therethrough. In yet still further aspects, this exemplary flooring product can further include a liquid adhesive that is a copolymer of polypropylene (PP).

In aspects where the flooring product has a unitary construction, the precoat layer can be a copolymer of the material forming the plurality of fibers, and the primary backing ensures that the precoat layer has a lower melting point than the fibers or the backing.

In other aspects, the first polymer composition is different from the second polymer composition. For example, the flooring product can include a polyester backing with polyamide fibers tufted therethrough, and any of the disclosed herein precoat layers anchoring these polyamide fibers to the polyester backing. In another example, the flooring product can include a polyamide backing with polypropylene (PP) fibers tufted therethrough and any of the disclosed herein precoat layers. It shall be understood that the construction of the flooring products is not restricted to the above combinations and can include any combinations of the disclosed materials herein.

In yet still further aspects, the flooring products comprise the plurality of fibers, the precoat layer, and the primary backing, each comprising any of the disclosed above biodegradation agents. It is understood that the biodegradation agent present in each component (a plurality of fibers, a precoat layer, a primary backing) can be the same or different. In some aspects, each component can degrade substantially at the same time. While in other aspects, the components can degrade at different times but within a predetermined period.

In still further aspects, the biodegradation of each component is determined by a percentage of each component degradation within 3 to 5 years. In some aspects, the disclosed herein adhesive composition comprising the biodegradation agent can degrade from 5% to 100% within 3-5 years, including exemplary value of 10%, 15%, 20%, 25%, 30%, 35%, 40%, 45%, 50%, 55%, 60%, 65%, 70%, 75%, 80%, 85%, 90%, 95%, and 99%. In still further aspects, the disclosed herein plurality of fibers comprising the biodegradation agent can degrade from 5% to 100% within 3-5 years, including exemplary value of 10%, 15%, 20%, 25%, 30%, 35%, 40%, 45%, 50%, 55%, 60%, 65%, 70%, 75%, 80%, 85%, 90%, 95%, and 99%. In yet still, further aspects, the disclosed herein primary backing comprising the biodegradation agent can degrade from 5% to 100% within 3-5 years, including exemplary value of 10%, 15%, 20%, 25%, 30%, 35%, 40%, 45%, 50%, 55%, 60%, 65%, 70%, 75%, 80%, 85%, 90%, 95%, and 99%.

In still further aspects, the flooring product disclosed herein can also comprise a secondary backing 208 shown in FIG. 3. The secondary backing 208 can be laminated to the primary backing 204 to give the flooring product dimensional stability and/or comfort. For example, in some aspects, the secondary backing can be foamed. While in other aspects, the secondary backing can be rigid. In some aspects, the secondary backing can comprise polypropylene; however other backing types, such as jute, polyamide, PVC (polyvinyl chloride), polyurethane, PET, polytrimethylene terephthalate (PTT), or any combination thereof can be used.

In certain aspects, the secondary backing can comprise nonwoven fabrics and can include, but are not limited to, spun-bond, wet-laid, melt-blown, and air-entangled fabrics. In some exemplary aspects, the nonwoven secondary backing may comprise a 60-120 gsm spunbond.

In yet other aspects, the secondary backing can comprise woven fabrics. In aspects in which a woven secondary backing is used, for example, the woven secondary backing may comprise 5-12 picks per inch and a weight of 2-8 oz/yd². For example, in some embodiments, the secondary backing can have a weight of 2-5 oz/yd². In other aspects, the secondary backing can have a weight of 3 oz/yd². In further embodiments, for instance, the secondary backing can comprise a carded and/or needled pad having a weight of 5-35 oz/yd².

In still further aspects, when the secondary backing is present, the flooring product can comprise a delamination strength of greater than 2.5 lb/inch. As above with the primary backings going beyond the weights discussed herein can further improve tear resistance, tensile strength, and tuft bind strength, but the secondary backing can become uneconomical as too much raw material is required to make a saleable product.

In still further aspects, the flooring product can include a reinforcing layer. In such exemplary aspects, the reinforcing layer or a scrim can be positioned between the precoat (or any additional adhesive if disposed on the precoat) and the secondary backing. In such exemplary aspects, the scrim reinforcing layer can comprise fiberglass, a nonwoven fabric, or woven fabric.

In still further exemplary and unlimiting aspects, any of the disclosed herein flooring products can have a tuft bind strength of greater than 6.25 lbs loop and greater than 3 lbs cut pile. In still further aspects, any of the disclosed herein flooring products can comprise a tear strength of greater than 25 lbs in the cross direction or machine direction. In still further aspects, any of the disclosed herein flooring products can comprise a tensile strength of greater than 100 lbs. in the cross direction or machine direction. Moreover, any of the disclosed herein flooring products can comprise dimensional stability of less than 3% total in both the cross and machine directions.

In still further aspects, the flooring products disclosed herein comprise a tile, a resilient flooring product, a carpet tile, a broadloom carpet, an area rug, a rubber mat, or a turf.

Also disclosed herein are fibers comprising a polymer composition comprising a polyolefin, a polyamide, a polyester, or a combination thereof, and a biodegradation agent, wherein the fiber degrades under conditions effective to cause biodegradability.

It is understood that the disclosed fibers can comprise any of the disclosed herein polyolefins, any of the disclosed herein polyamides, and/or any of the disclosed herein polyesters. It is also understood that the biodegradation agent can be any of the disclosed herein biodegradation agents. Also disclosed herein are yarns comprising these fibers. In addition, also disclosed is an article comprising these yarns.

### METHODS

Also disclosed herein are methods of making the disclosed adhesive compositions and the flooring products.

In some aspects, disclosed is a method of the adhesive composition disclosed herein by forming a homogeneous composition comprising any of the disclosed above latex and the biodegradation agents. In certain aspects, the biodegradation agent can be added as a liquid, a powder, or a combination thereof. In such exemplary aspects, the biodegradation agent can be added to a batch of latex. In some aspects, the biodegradation agent can be injected into a tank comprising the latex during continuous mixing to ensure that a homogeneous composition of the latex and the biodegradation agent is formed. The formed homogeneous mixture is compounded to form the adhesive composition.

Still further disclosed are methods of making the disclosed herein fibers. In such aspects, the methods comprise first forming a first compound composition comprising: i) a biodegradation agent; and ii) a carrier. In such aspects, any of the disclosed herein biodegradation agents can be used. In still further aspects, the carrier can be any polymer known in the art and suitable for the specific application. In certain aspects, the carrier can be chosen from the first polymer composition and/or second polymer composition as disclosed above.

In still further aspects, the first compound composition is extruded to form a plurality of pellets. In still further aspects, the first compound composition is mixed with a virgin polymer composition to form a homogeneous mixture. In such exemplary aspects, the virgin polymer can be the same as the carrier. While in other aspects, the virgin polymer can be different. In still further aspects, the virgin polymer can be any of the first and/or the second polymer compositions disclosed above. The methods of making the fibers further comprise extruding the homogeneous mixture to form the fiber.

The fibers can be extruded to have any shape or dimension suitable or desirable. In certain aspects, the fibers can undergo any post-spinning processes generally recognized as useful in preparing polymeric fibers. For example, the fibers may be as-spun or heat-set. By “fibers,” reference is made to items recognized in the art as fibers, such as continuous filaments, monofilaments, staple fibers, and the like. The fibers can be round or have other shapes, such as octalobal, delta, sunburst (also known as sol), scalloped oval, trilobal, tetra-channel (also known as quatra-channel), scalloped ribbon, ribbon, starburst, and the like. The fibers may also be solid, hollow, or multi-hollow. The fibers are used to make yarns, and the fibers or yarns can be used to prepare tufted textiles as described herein, such as carpets, rugs, mats, and the like.

The plurality of fibers can be formed into yarn. The yarn can then be prepared according to any method for preparing yarns recognized in the art. For example, the yarns of the present disclosure could be partially oriented yarn, spun drawn yarn, textured yarn, friction false-twisted yarn, and bulk continuous filament (“BCF”) yarn. Example steps in preparing BCF yarn include spinning (e.g., extruding, cooling, and coating filaments), single-stage or multi-stage drawing (such as with heated rolls, heated pin or hot fluid assist) at a defined temperature and draw ratio, annealing, entangling, optionally relaxing, and winding the filaments on a package for subsequent use. Yarns can also comprise staple fibers of varying lengths.

Also disclosed are methods of making the disclosed herein flooring products. In such aspects, the methods comprise a) disposing a curable composition comprising a latex and a biodegradation agent on a back surface of a flooring structure; wherein the latex has a total solids content from 50 wt % to 90 wt %, and wherein the biodegradation agent is present in an amount from about 0.5 wt % to 5 wt % based on the total solids content of the latex, and b) curing the curable composition to form a backing.

It is understood that any of the disclosed herein latexes and biodegradation products can be used. In still further aspects, the curable composition can be metered out in a gauge of 15-40 oz/unit area of the flooring product, including exemplary values of 17, 20, 22, 25, 27, 30, 32, 25, and 37 oz/unit area [[n still further aspects, the backing can have a thickness of 0.3 mm to 3 cm, including exemplary values of 0.5 mm, 0.7 mm, 1 mm, 2 mm, 5 mm, 7 mm, 1 cm, 1.5 cm, 2 cm, and 2.5 cm. In yet further aspects, the thickness can be between 0.5 mm to 2. 5 cm or between 1 mm to 1 cmYet also disclosed additional methods of making some of the disclosed herein flooring products. In such aspects, the methods comprise a) providing a primary backing having a face side and a back side; b) tufting a plurality of fibers through the primary backing such that at least a portion of the plurality of fibers extends from the face surface of the primary backing and wherein at least a portion of fibers is exposed at the back surface of the primary backing. In some exemplary aspects, tufting the plurality of fibers into the primary backing can comprise tufting with a tufting machine as understood by a person having ordinary skill in the art.

In still further aspects, a precoat layer comprising any of the disclosed herein adhesive composition is applied to the back side of the primary backing. In some aspects, the precoat layer comprises any of the disclosed herein latexes and biodegradation agents. Yet in other aspects, in addition or in alternative to this latex-containing adhesive, other adhesive materials as disclosed herein can also be applied.

A number of aspects of the disclosure have been described. Nevertheless, it will be understood that various modifications may be made without departing from the spirit and scope of the disclosure. Accordingly, other aspects are within the scope of the following claims.

1-113. (canceled)

114. An adhesive composition comprising:
a latex; and
a biodegradation agent;
wherein the latex has a total solids content from 50 wt % to 90 wt %, and wherein the biodegradation agent is present in an amount from about 0.5 wt % to 5 wt % based on the total solids content of the latex mixture;
wherein the biodegradation agent comprises of one or more of a biodegradable polymer, a carrier resin, glutaric acid or its derivatives, carboxylic acid compounds or its derivatives, a swelling agent, an inorganic filler, an oxo-biodegradable additive, hydroperoxides, prodegradants; and
wherein the biodegradation agent comprises a chemoattractant compound selected from the group of a furanone, 3,5-dimethylyentenyl-dihydro-2(3H)furanone isomer mixtures, emoxyfurane, N-acyl homoserine lactones, other furanone derivatives, or a combination thereof.

115. The adhesive composition of claim 114, wherein the latex mixture comprises a carboxylated styrene-butadiene (XSB) latex copolymer, a styrene-butadiene resin (SBR) latex, a butadiene-methyl methacrylate (BDMMA) latex, a styrene-acrylic latex, a pure acrylic latex, or any combination thereof.

116. The adhesive composition of claim 115, wherein the adhesive composition degrades under conditions effective to cause biodegradability.

117. The adhesive composition of any one of claim 116, wherein the conditions effective to cause biodegradability comprises exposure to an environment comprising one or more microorganisms.

118. The adhesive composition of claim 117, wherein the conditions effective to cause biodegradability comprises an aerobic waste management route or an anaerobic waste management route.

119. The adhesive composition of claim 118, wherein the aerobic or anaerobic waste management route comprises digester, landfill, or compost.

120. The adhesive composition of any preceding claim 119, wherein the biodegradable polymer comprises polylactic acid, poly(lactic-co-glycolic acid), polypropylene carbonate, polycaprolactone, polyhydroxyalkanoate, chitosan, gluten, or one or more aliphatic/aromatic polyesters.

121. The adhesive of claim 120, wherein the one or more aliphatic/aromatic polyesters comprise polybutylene succinate, polybutylene succinateadipate, polybutylene succinate-sebacate, or polybutylene terephthalate-coadipate, or a mixture thereof.

122. The adhesive composition of claim 121, wherein the swelling agent comprises one or more of a natural fiber, a cultured colloid, a cyclo-dextrin, polylactic acid, or mixtures thereof.

123. The adhesive composition of claim 122, further comprising a filler comprised of calcium carbonate, aluminum trihydrate, barite, feldspar, cullet, fly ash, limestone, or any combination thereof.

124. A flooring product comprising:
a primary backing material having a face side and a backside;
a plurality of fibers attached to the primary backing material and extending from the face surface of the primary backing, wherein the plurality of fibers comprises a composition comprising:
a first polymer composition comprising a polyolefin, a polyamide, a polyester, or
a combination thereof, and
a biodegradation agent; and
wherein the biodegradation agent comprises one or more of a biodegradable polymer, a carrier resin, glutaric acid or its derivatives, carboxylic acid compounds or its derivatives, a swelling agent, an inorganic filler, an oxo-biodegradable additive, hydroperoxides, prodegradants; and
wherein the biodegradation agent comprises a chemoattractant compound selected from the group consisting of a furanone, 3,5-dimethylyentenyl-dihydro-2(3H)furanone isomer mixtures, emoxyfurane, N-acyl homoserine lactones, other furanone derivatives, or a combination thereof.

125. The flooring product of claim 124, wherein the plurality of fibers degrade under conditions effective to cause biodegradability.

126. The flooring product of claim 125, wherein the conditions effective to cause biodegradability, comprises exposure to an environment comprising one or more microorganisms.

127. The flooring product of any one of claim 126, wherein the conditions effective to cause biodegradability comprise an aerobic waste management route or an anaerobic waste management route

128. The flooring product of claim 127, wherein the aerobic or anaerobic waste management route comprises digester, landfill, or compost.

129. The flooring product of any one of claim 128, wherein the plurality of fibers are present in a yarn.

130. The flooring product of any one of claim 129, wherein the first polymer composition comprises a polyamide, and the polyamide comprises nylon 6, nylon 66, nylon 666, nylon 610, nylon 512, nylon 11, or nylon 12, or a combination thereof.

131. The flooring product of any one of claims 130, wherein the first polymer composition comprises a polyester and the polyester comprises polyethylene terephthalate ester, polypropylene terephthalate, polytrimethylene terephthalate ester, polybutylene terephthalate ester, or any combination thereof.

132. The flooring product of any one of claim 131, wherein the first polymer composition comprises a polyolefin, and the polyolefin comprises polyethylene, polypropylene, or a combination thereof.

133. The adhesive composition of claim 132, further comprising a filler comprised of calcium carbonate, aluminum trihydrate, barite, feldspar, cullet, fly ash, limestone, or any combination thereof.
